(19) United States
(12) Patent Application Publication
(10) Pub. No.: US 2014/0019176 A1
(43) Pub. Date: Jan. 16, 2014

(54) APPARATUS AND METHOD FOR SEARCHING AND BOOKING A COMPLETE TRAVEL ITINERARY

(71) Applicant: Triptility, LLC, (unknown)

(72) Inventor: Steven Jay MANDELBAUM, Washington, DC (US)

(73) Assignee: Triptility, LLC

(21) Appl. No.: 13/925,556

(22) Filed: Jun. 24, 2013

Related U.S. Application Data
(63) Continuation of application No. 13/161,470, filed on Jun. 15, 2011, now abandoned.
(60) Provisional application No. 61/354,703, filed on Jun. 15, 2010.

(51) Int. Cl. G06Q 10/02

(52) U.S. Cl. CPC G06Q 10/025
USPC 705/6

(57) ABSTRACT

A travel system uses information pertaining to an initial origin and an ultimate destination of a traveler, instead of specific airports (or other travel depots) to plan and book a complete itinerary. The complete itinerary may include transportation, lodging, and/or car rentals for one or more travel legs to/from one or more destinations. In some embodiments, the travel system may import information associated with one or more appointments from the traveler's calendar to automatically plan and book the complete itinerary.

### CROSS-REFERENCE TO RELATED APPLICATIONS

This application claims priority to U.S. Provisional Application No. 61/354,703, entitled “Apparatus and Method for Searching and Booking a Complete Travel Itinerary,” filed on Jun. 15, 2010, which is incorporated herein in its entirety.

### FIELD OF THE INVENTION

The invention generally relates to travel search, planning, tracking, reservations, booking, ticketing and sales.

### BACKGROUND OF THE INVENTION

Conventional travel booking systems and methods focus on searching for, locating and booking travel between one or more airports, one or more rail stations, and/or one or more bus stations. Such systems and methods ignore that travelers often must utilize multiple means of transportation, including, but not limited to ground transportation, to arrive at their ultimate destination.

An ultimate destination is broadly defined as a specific location to which a traveler must travel. An example would be a meeting at the specific location of the Empire State Building in New York City. This specific location is distinguished from a waypoint or depot, such as an airport or train station, which may be part of any travel from one destination to another, but is not the location for which the traveler is destined. An ultimate or initial origin is broadly defined as a specific location from which a traveler begins his trip (e.g., their house or office location). A traveler's ultimate destination(s) can be served by a multitude of different airports and/or rail stations, each with different air or rail service schedules or fares.

Conventional travel booking systems require a user to search independently for air, rail, and/or ground transportation options, and manually compare and combine these results to evaluate and determine possible complete travel itineraries. Furthermore, the user must compile the information from multiple decentralized sources into a complete travel itinerary. Finally a traveler must then weigh different options and select the best itinerary.

This process can be time consuming and resource intensive. Additionally, because the number of factors to be considered result in many potential permutations, creating a complete travel itinerary manually can be difficult and subject to error. Likewise, even a slight change in travel plans requires the user to repeat the manual process. Current systems and methods yield sub-optimal results and do not optimize resources effectively or efficiently.

### BRIEF DESCRIPTION OF THE DRAWINGS

The accompanying drawings, which are included to provide a further understanding of the invention and are incorporated in and constitute a part of this specification, illustrate various exemplary implementations of the invention and together with the detailed description serve to explain various principles and/or aspects of the invention.

FIG. 1 is an exemplary illustration of a process for entering and validating ultimate destinations and determining air options (i.e., potential routings), in accordance with an embodiment of the invention.

FIG. 2 is an exemplary illustration of a process for entering and validating ultimate destinations and determining hotel options (i.e., potential lodging options), in accordance with an embodiment of the invention.

FIG. 3 is an exemplary illustration of a process for determining car/ground transportation options (i.e., potential ground transportation options), in accordance with an embodiment of the invention.

FIG. 4 is an exemplary illustration of a process for combining multiple travel segments into a single itinerary, in accordance with an embodiment of the invention.

FIG. 5 is an exemplary illustration of a process for entering and validating ultimate destinations and determining direct drive options, in accordance with an embodiment of the invention.

FIG. 6 is an exemplary illustration of a graphic user interface of a travel itinerary, in accordance with an embodiment of the invention.

FIG. 7 is an exemplary illustration of a graphic user interface of a traveler's profile including supplier frequent traveler accounts, status and preferences, in accordance with an embodiment of the invention.

FIG. 8 is an exemplary illustration of traveler flow options and terminology, in accordance with an embodiment of the invention.

FIG. 9 is an exemplary illustration of travel segments included in a travel leg, where one of the travel segments comprises an air travel segment, in accordance with an embodiment of the invention.

FIG. 10 is an exemplary illustration of a schematic diagram of a system in which various embodiments of the invention may operate.

FIG. 11 is an exemplary illustration of a graphic user interface of user search inputs, in accordance with an embodiment of the invention.

FIG. 12 is an exemplary illustration of a process for dynamic filtering of air itineraries received from an air data service, in accordance with an embodiment of the invention.

FIG. 13 is an exemplary illustration of a process and schematic of importing appointments from external data sources, in accordance with an embodiment of the invention.

FIG. 14 is an exemplary illustration of a process and schematic of monitoring appointments from external data sources, in accordance with an embodiment of the invention.

FIG. 15 is an exemplary illustration of a graphic user interface of drive, check-in and check-out times from initial origin(s)/ultimate destination(s) to closest airports (i.e., travel depots), in accordance with an embodiment of the invention.

FIG. 16 is an exemplary illustration of a graphic user interface of user appointment/ultimate destination inputs, in accordance with an embodiment of the invention.

FIG. 17 is an exemplary illustration of a scoring formula for potential routings (e.g., air service), in accordance with an embodiment of the invention.

FIG. 18 is an exemplary illustration of a scoring formula for potential lodging options, in accordance with an embodiment of the invention.

FIG. 19 is an exemplary illustration of a scoring formula for potential ground transportation options (e.g., car rental, etc.), in accordance with an embodiment of the invention.

FIG. 20 is another exemplary illustration of a graphic user interface of user search inputs, in accordance with an embodiment of the invention.

### DETAILED DESCRIPTION

It will be readily understood that the components of the invention, as generally described and illustrated in the figures herein, may be arranged and designed in a wide variety of different configurations. Thus, the following detailed description of the embodiments of a method, an apparatus, and a computer program product, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with such embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

According to various embodiments, the invention relates to an automated system for building and displaying travel itineraries for a traveler that include a plurality of travel segments that get the traveler door-to-door from an initial origin to an ultimate destination. In some embodiments, the travel itineraries may aggregate one or more transportation travel segments. Such transportation travel segments may include one or more air travel segments, one or more rail travel segments, one or more ground travel segments, and/or one or more other transportation travel segments. In some embodiments, the travel itineraries may aggregate one or more non-transportation travel segments. Such non-transportation travel segments may include one or more hotel reservations, one or more restaurant reservations, one or more entertainment reservations, and/or other non-transportation travel segments. In some embodiments, the travel itineraries may aggregate one or more transportation travel segments with one or more non-transportation travel segments. In some embodiments, the travel itineraries factor in a check-in time (e.g., time drop off rental car, time to obtain board passes, time to check luggage, time to proceed through security, time to walk to gate, etc.) and a check-out time (e.g., time to deboard, time to retrieve checked luggage, time to walk to ground transportation, time to pick up rental car, etc.) required for these travel segments. In some embodiments, the travel itineraries factor in an appropriate buffer to account for preferences and/or potential delays.

In various embodiments, the system receives an initial origin of a traveler and an earliest departure time before which the traveler cannot depart the initial origin (e.g., a time before which the travel itinerary cannot begin). In various embodiments, the system receives an ultimate destination of the traveler and a latest arrival time by which the traveler must arrive at the ultimate destination. For purposes of this description, each travel leg may include an initial origin, an earliest departure time, an ultimate destination, and a latest arrival time. Also for purposes of this description, each travel leg may include one or more travel segments. In various embodiments, a trip may have multiple ultimate destinations and therefore, multiple travel legs. In such a trip, each ultimate destination may become the initial origin for the next travel leg as would be appreciated.

Various embodiments of the invention include systems, methods, and/or computer program products that determine optimal travel itineraries based on travel between at least one initial origin and at least one ultimate destination.

Various embodiments of the invention include systems, methods, and/or computer program products that use a mapping service.

Various embodiments of the invention include systems, methods, and/or computer program products that use a distribution system that includes transportation schedules (including departure times and/or arrival times), inventory availability, available features, options and/or amenities, and/or fares for various transportation modes, which may include air carriers, rail carriers, and other common or private carriers.

Various embodiments of the invention include systems, methods, and/or computer program products that that determine the closest travel depots, which may include airports, rail stations or departure/arrival points for other common or private carriers.

Various embodiments of the invention include systems, methods, and/or computer program products that determine various travel segments between the initial origin and ultimate destination, where one or more of the travel segments correspond to potential routings therebetween.

Various embodiments of the invention include systems, methods, and/or computer program products that score potential travel itineraries or portions thereof (e.g., potential routings, potential lodging options, potential ground transportation options, etc.). In some of these embodiments, the scoring may be customized by the user, the traveler, a group associated with the traveler, an organization associated with the traveler, and/or in accordance with various travel policies associated with the traveler.

Various embodiments of the invention include systems, methods, and/or computer program products that score potential travel itineraries or portions thereof based various scoring factors including, but not limited to: duration of travel, prices (including air fare, rail fare, rental car prices), on-time ratings, mileage reimbursements, fuel, lodging costs, per diems, cost of time for travel, ancillary charges and services, specific seat availability, amenity availability and cost, traveler and/or group preferences, traveler and/or group past habits or patterns.

Various embodiments of the invention include systems, methods, and/or computer program products that provide for reserving, booking and selling travel services.

Various embodiments of the invention include systems, methods, and/or computer program products that generating new travel itineraries from existing booked itineraries, based on changes to the initial origin or ultimate destination. Such embodiments may determine changes in fares, schedules and/or fees.

Various embodiments of the invention include systems, methods, and/or computer program products that import an ultimate destination(s) of the traveler and/or latest arrival times from external systems, such as an electronic calendar associated with the traveler.

Various embodiments of the invention include systems, methods, and/or computer program products that permit the user, in a single action or gesture (e.g., “one-click”), to book (and subsequently receive tickets and/or reservations for) a complete travel itinerary comprising multiple travel segments (e.g., air fare, lodging, car rental, etc.).

Various embodiments of the invention include systems, methods, and/or computer program products that generate a complete travel itinerary in response to receipt of the ultimate destination. Various ones of such embodiments generate the complete travel itinerary in response to receipt of the initial origin. In various embodiments, the ultimate destination and/or the initial origin may be received from a user or the traveler. In various embodiments, the ultimate destination and/or initial origin may be received from an external system (e.g., an electronic calendar associated with the traveler, etc.). In various embodiments, the initial origin may correspond to the actual location of the traveler and be received from a positioning device on the traveler's person. In various embodiments, the initial origin may correspond to and be determined from the location associated with one or more appointments on the traveler's electronic calendar.

In various embodiments of the invention, the complete travel itinerary includes transportation and lodging and/or events.

In various embodiments of the invention, the user can modify one or more items on the travel itinerary prior to or after booking.

Various embodiments of the invention include systems, methods, and/or computer program products score potential lodging options based on one or more scoring factors including: the lowest price or nightly rate for the room (and tax, if available for calculation); the traveler's preference for hotel brand; the traveler's status with the hotel brand; past reviews of the hotel by the traveler or others; traveler's or group's preference for hotel brand or particular property; distance from appointments, events or other waypoints; quality level/category of the hotel (star rating or luxury category); traveler, user or group past habits or patterns; availability of amenities and associated prices (free/paid internet access, pool, and/or business center) and availability and ranges of courtesy shuttles (i.e., to/from travel depots, business centers, etc.).

Various embodiments of the invention include systems, methods, and/or computer program products score potential ground transportation options based on one or more scoring factors including: the lowest rate for the car rental (and tax, if available for calculation); the traveler's preference for car rental provider brand; the traveler's status with the car rental provider brand; availability of amenities and associated prices (satellite radio, navigation system, and/or child car seat); traveler's or group's preference for car rental provider brand; traveler, user or group past habits or patterns; and quality level/category of the car (star rating or luxury category).

Various embodiments of the invention include systems, methods, and/or computer program products provide revised itineraries considering tickets and other bookings from the original or revised itinerary.

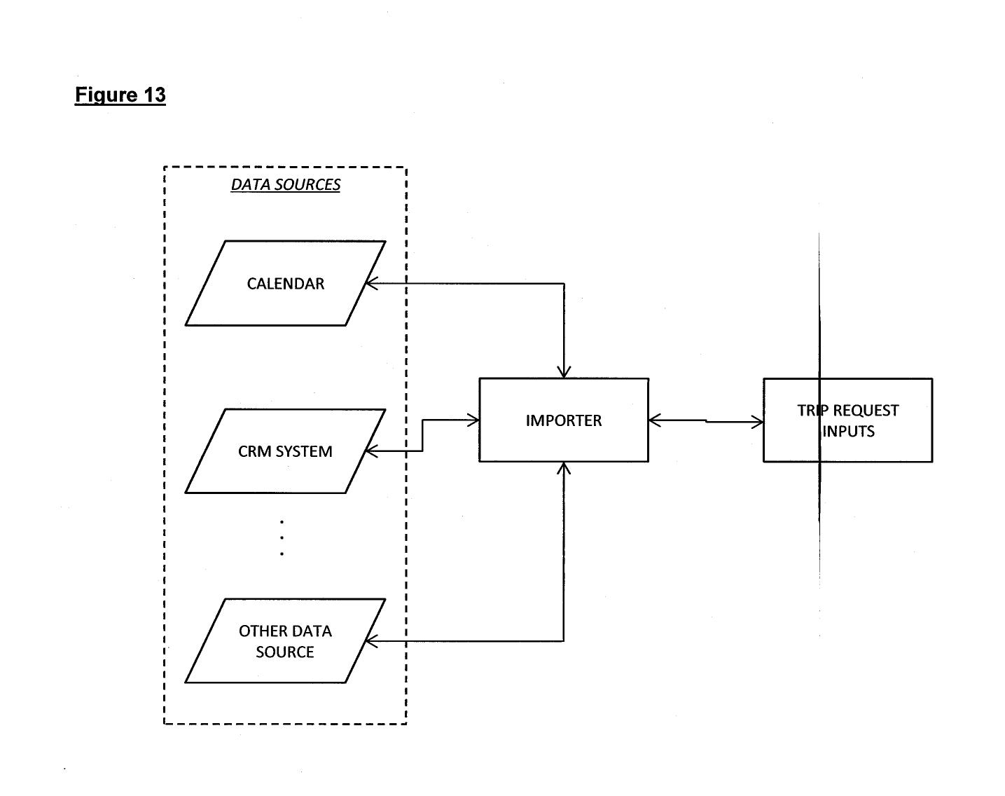

In various embodiments, the system may import various information (e.g., calendar information, such as but not limited to appointments; locations and addresses associated with appointments, dates and times associated with appointments, directions to the appointments, contact information associated with the appointment, etc.) from various data sources including: an electronic calendar, contact list, third party information system, or device associated with the traveler (i.e., ical address or file or item; connection to calendar server or application such as Microsoft Exchange or Microsoft Outlook; customer relationship or sales force automation system such as salesforce.com, ACT, Goldmine, Microsoft CRM, Siebel etc.; or other information, including calendar information, available via the traveler's computer, mobile device, smartphone, etc.). FIG. 13 illustrates a system that may be used to import information from various data sources as would be appreciated.

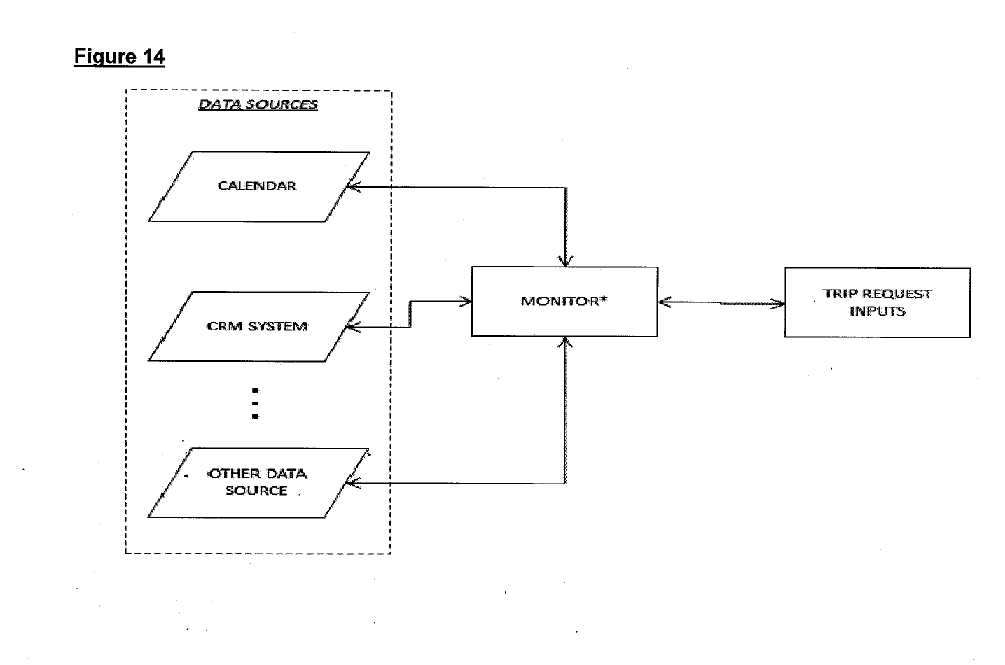

In various embodiments, a monitoring system may determine whether a travel itinerary has been booked for an appointment in the electronic calendar (e.g., calendar item) associated with the traveler, and if not, may automatically (i.e., without further user interaction) prepare a proposed travel itinerary for that appointment, and in some cases, book the proposed travel itinerary. In some embodiments of the invention, the monitoring system may periodically compare the appointments in the traveler's calendar against any booked trips. In some of such embodiments, the monitoring system may determine whether the appointment falls within a particular booking time window (i.e., a predetermined time, such as, for example, three weeks, prior to the appointment) and prepares the proposed travel itinerary to take advantage of early booking prices, for example. In various embodiments, the monitoring system may determine whether a new calendar item or a change to an existing calendar item impacts a travel itinerary that has already been booked and whether such travel itinerary can still be traveled. In various embodiments, the monitoring system may present potential options for changes to the travel itinerary to accommodate the new or changed calendar item in a cost-effective manner. Such monitoring systems may require the traveler's credentials to access such data sources as would be appreciated. FIG. 14 illustrates a system that may be used to monitor various data sources as would be appreciated. In some embodiments of the invention, the monitoring system, may operate, at least in part, on a mobile device of the traveler (i.e., on the client-side) and access and monitor the traveler's calendar via the mobile device. In some embodiments of the invention, the monitoring system, may operate, at least in part, on top of or in connection with the traveler's calendar or email client (e.g., Microsoft Outlook, Microsoft Exchange, ical, etc.) in order to monitor new appointments or changes to appointments, and thereby initiate new travel itineraries and/or changes to itineraries as would be apparent.

In some embodiments of the invention, the user may select the appointment on a traveler's calendar and initiate a new travel itinerary or change to an existing itinerary that is associated with the appointment. This may be accomplished by, for example, right clicking on the appointment and selecting an item that in turn causes the appointment (or relevant information associated therewith) to be “pushed” for processing of an itinerary.

In various embodiments, the system may receive a current location from a positioning device on the traveler's person and in comparison to the traveler's appointments and booked itinerary determine that a change must be made. In some embodiments the system may further propose, book, change and/or re-book a new suitable itinerary.

In various embodiments, the system may receive a disruption notification, such as, but not limited to a, flight delay, flight cancellation, and/or a weather alert and in comparison to the traveler's appointments and booked itinerary determine that a change must be made. In some embodiments the system may further propose, book, change and/or re-book a new suitable itinerary.

In various embodiments, the system receives at least one ultimate destination and an associated latest arrival time. In some embodiments, the system also receives an initial origin. In some embodiments, the system also receives an earliest departure time. In various embodiments of the invention, the system such received information against a mapping engine/service and captures the relevant geographical and time zone information.

In embodiments where the system receives multiple ultimate destinations and their associated arrival times, the system may use the ultimate destination from one travel leg as the initial origin for the next travel leg as would be appreciated. For purposes of this description, a single travel leg (i.e., one initial origin and one ultimate destination) is described although it would be appreciated how additional travel legs (i.e., multiple ultimate destinations) may be accommodated into a single multi-leg itinerary.

In various embodiments, the mapping engine/service may identify one or more travel depots (e.g., airports, rail stations, bus stations, and/or other common or private carrier arrival/departure points) that are near, or closest to, the initial origin and/or may identify the corresponding one or more travel depots that are near, or closest to, the ultimate destination. In some embodiments, the mapping engine/service may determine various distances and travel times associated with getting to and/or from each travel depot. In some embodiments, distance and travel times associated with traveling between travel depots may also be determined. In some embodiments, the travel times may account for various travel delays such as traffic delays, airport delays, flight delays, or other travel delays. In some embodiments, the travel times may be adjusted based on time of the day/year during which the travel will occur. In various embodiments, the travel times may be adjusted based on actual delays, projected delays, historical delays, real-time delays, or other measures or estimates of delays. In various embodiments, a predefined or user specified list of closest airports may be used for some initial origins or ultimate destinations. In various embodiments, other mechanisms may be used to determine closest travels depots as would be apparent.

In various embodiments, the system evaluates or filters one or more potential routings between one or more travel depots for each travel leg. Each potential routing may be evaluated or filtered in part based on an available time period between the earliest departure time and the latest arrival time for the travel leg. In some embodiments, each potential routing may be evaluated or filtered based on drive times to/from the travel depots, check-out and check-in times, and/or other times as would be appreciated. In some embodiments, an additional buffer time period, static or variable, may be included to account for delays (real or estimated), traveler experience level, traveler comfort level, and/or other buffer times. In some embodiments, a user of the system may adjust/override various assumptions associated with this filtering and the system may re-filter the potential routings.

In some embodiments, the system gathers various transportation information for each potential routing, where the transportation information may include transportation schedules (departure time, arrival time, travel time, etc.), transportation inventory availability, available transportation amenities, transportation amenities cost, and/or transportation fares. In some embodiments, the system may gather the transportation information from a distribution system which may include a conventional travel global distribution system (“GDS”) as would be appreciated. In some embodiments, the system may gather the transportation information from sources that provide either fare and/or inventory information (e.g., ITA Solutions QPX, Everbread, OAG, ATPCO). In some embodiments, the system may gather the transportation information directly from the transportation suppliers/providers. In some embodiments, the system may gather sufficient transportation information to provide a significant number of potential routings for the travel leg. In some embodiments, the system gathers transportation information pertaining to multiple forms of transportation modes (i.e., planes, trains, buses, or other common or private carriers) or combinations of transportation modes. In some embodiments, the system provides a sufficient number of potential routings over the entire available time period to allow the traveler opportunities to change or override assumptions without gathering additional transportation information. In some embodiments, the system may ignore travel time to travel depots, check-in/check-out times, or other similar time periods.

In some embodiments, the system may score various one of the potential routings to determine one or more acceptable travel itineraries based on one or more scoring factors. In some embodiments, the system may score various one of the potential routings to determine an optimal travel itinerary. In some embodiments, the system may score various one of the potential routings to determine a travel itinerary with lowest cost. In some embodiments, the system may score various one of the potential routings to determine a travel itinerary with shortest overall travel time. In some embodiments, the system may score various one of the potential routings to determine a travel itinerary with highest level of traveler convenience (i.e., single transportation mode, no layovers, etc.). In some embodiments, the system may score various one of the potential routings to determine a travel itinerary optimized over a combination of factors (e.g., cost, travel time, convenience, etc.). In some embodiments, the system may score various one of the potential routings to determine a travel itinerary that factors in traveler loyalty programs (e.g., frequent flyer programs, etc.) or travel preferences. In some embodiments, the system may score various one of the potential routings to determine a travel itinerary that factors in traveler and/or group past habits or patterns.

In some embodiments, the system scores potential routings based on various scoring factors, which may include, but are not limited to, duration of travel, prices including air fare, rail fare, rental car prices, mileage reimbursements, fuel, lodging costs, per diems, cost of time for travel, traveler's hourly rate for travel, ancillary charges and services, traveler, group or organizational preferences, preferred supplier (e.g., airline, rental car company, and/or preferred hotel chain/specific property), traveler loyalty programs, or other scoring factors. In some embodiments, the system scores potential routings based on scoring factors such seat availability, “on-time” arrival percentages, “on-time” departure percentages, actual historical and/or predicted departure and arrival times/delays, upgrade availability, seat class (first, business, coach, refundable fare, etc.), seat type (bulkhead row, emergency row, aisle seat, window seat, middle seat, etc.), fare class, fare restrictions, available or desired amenities and prices, number of connections, duration of layovers, location of connection(s) (i.e., avoid Denver in winter, avoid Chicago on summer afternoons, avoid Laguardia, etc.). In some embodiments, such scoring may be customizable by a user or group of users, travel department, traveler, etc. or in accordance with various travel policies. In some embodiments, such scoring may be weighted to achieve overall objectives of the traveler or organization such as reducing travel costs, or reducing travel times, or other objectives.

In some embodiments, the system displays one or more of the scored routings as travel itineraries. In some embodiments, the system displays the optimal travel itinerary. In some embodiments, the system displays one or more of the travel itineraries for comparison purposes. For example, the travel itinerary with the lowest cost may be displayed with the travel itinerary with the shortest overall travel time or the highest level of customer convenience. In some embodiments, the system permits further refinement of assumptions causing the system to re-filter the transportation information and re-score the potential routings.

In some embodiments, the system displays the optimal travel itinerary. In some embodiments, the system displays and permits selection from multiple travel itineraries with their scores. In some embodiments, the system displays and permits selection from multiple travel itineraries that displays line-by-line comparison of each component of the travel itineraries. In some embodiments, the system displays the optimal travel itinerary with one or more alternate itineraries which may be selectable by the user. In some embodiments, the system displays the optimal travel itinerary with a selected travel itinerary for purposes of comparison. In some embodiments, deviations between the optimal travel itinerary and the selected travel itinerary may be evaluated against various traveler or organizational objectives or organizational travel policies. In some embodiments, the system may accept limitations on such deviations thereby eliminating certain travel itineraries from booking by the traveler in accordance with organizational travel policies, etc.

In some embodiments, the travel itinerary includes the initial origin, the ultimate destination, drive time from initial origin to the travel depot, check-in time(s), check-out times(s), travel time between each travel depot for various travel segments (namely, transportation travel segments), and/or drive time from the travel depot to ultimate destination for each travel leg. In some embodiments, the travel itinerary may include costs or fares associated with one or more of the travel segments (or combinations of travel segments), which may include one or more transportation travel segments and/or non-transportation travel segments. In some embodiments, the travel itinerary may also include driving directions (or links or other access to such directions) as would be appreciated. In some embodiments, the travel itinerary may also include lodging, restaurant, activities/events, and pre-arranged ground transportation (e.g., limousine service, car rental, etc.). In some embodiments, the travel itinerary may include the traveler's appointments at each ultimate destination, including the address, start and end times, driving directions, and/or appointment contact information.

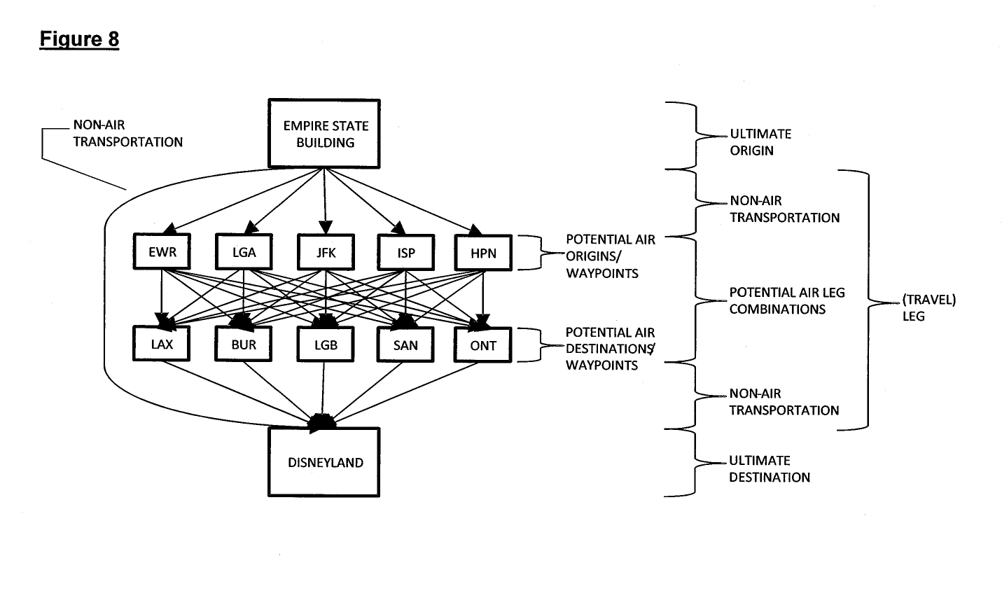

FIG. 8 illustrates an example useful for describing various contexts and terminology associated with various embodiments of the invention. As illustrated, FIG. 8 includes a trip between an initial origin, namely, the Empire State Building, and an ultimate destination, namely, Disneyland. In this non-limiting example, travelling from the initial origin to the ultimate destination may be accomplished by a) driving (i.e., non-air transportation) or b) flying. A number of travel depots (illustrated as potential air origins/waypoints in this example) are near the initial origin, namely EWR, LGA, JFK, ISP and HPN. Likewise a number of travel depots (illustrated as potential air destinations/waypoints in this example) are near the ultimate destination, namely LAX, BUR, LGB, SAN, ONT. Various potential routings exist between each of the airports near the initial origin and each of the airports near the ultimate destination (illustrated as potential air leg combinations). As also illustrated, each of the airports near the initial origin is associated with some form of non-air transportation (e.g., a drive) between the initial origin and the respective airport; and each of the airports near the ultimate destination is associated with some form of non-air transportation (e.g., a drive) between the respective airport and the ultimate destination. As illustrated in FIG. 8, a travel leg is comprised of travel from the initial origin to one of the airports, travel via a potential routing between airports, and travel from one of the airports to the ultimate destination.

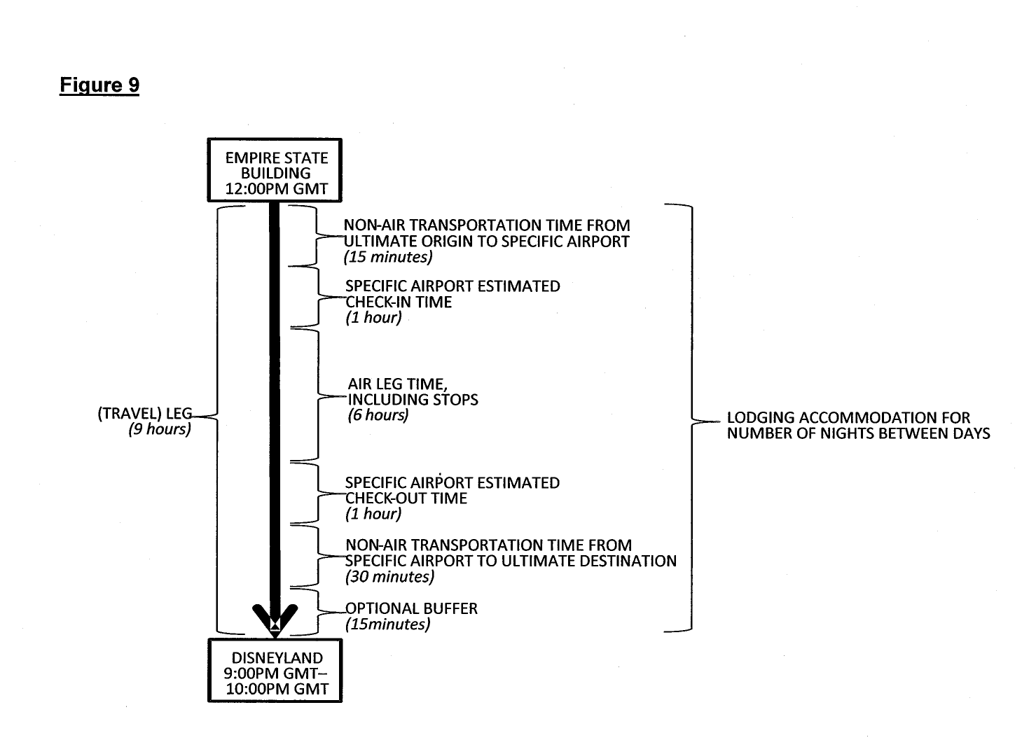

FIG. 9 illustrates various travel components and their associated times that form the travel leg described above in FIG. 8. As illustrated, non-air transportation from the initial origin begins at the latest departure time of 12:00 pm GMT. The duration of this transportation is 15 minutes to a specific departure airport. The specific departure airport has an estimated check-in time of 1 hour prior to the departure of the flight (i.e., air leg). The duration of the flight(s) comprising the air leg is 6 hours, inclusive of any stops or connections. The specific arrival airport has an estimated check-out time of 1 hour after arrival of the flight. Non-air transportation to the ultimate destination has a duration of 30 minutes. In addition, an optional buffer of 15 minutes is used to ensure arrival at the ultimate destination at the latest arrival time of 9:00 pm GMT.

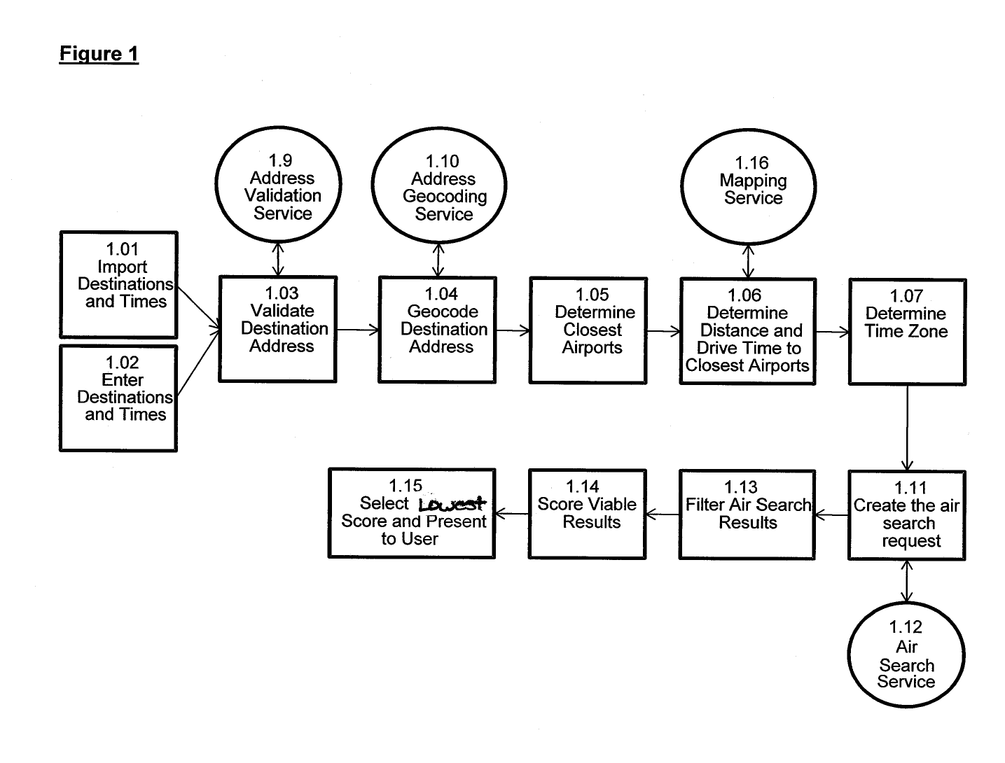

FIG. 1 illustrates various operations for determining potential routings for one or more transportation modes (illustrated as air transportation in FIG. 1) according to various embodiments of the invention. In some embodiments, the system receives an initial origin, an earliest departure time (which may include a departure date), an ultimate destination, and/or a latest arrival time (which may include an arrival date). As illustrated, the system may receive such information via a user/traveler entering such information into the system, for example in operation 1.02, or the system may receive such information by importing such information from, for example, an electronic calendar of the traveler, in operation 1.01.

In some embodiments, the system may receive information regarding one or more specific appointment(s) or event(s) of the traveler at each ultimate destination, including, but not limited to, the address(es), start and end times, and time buffers before the start time(s) and after the end time(s) of the appointments.

In some embodiments, the system may store an identifier either provided by a user or retrieved from an electronic calendar. Such an identifier could be used for later reporting or expense recovery (e.g., an appointment number that matches back to a sales force automation system). In some embodiments, the system may read events from electronic mail or other document system by, for example, parsing time/date and location information included in such documents.

In an operation 1.03, the system may validate each initial origin and/or each ultimate destination (or other relevant location input). Such validation may be obtained, for example, via an address validation service 1.9. In some embodiments, in an operation 1.04, the system may geocode each initial origin and/or each ultimate destination (or other relevant location input). Such geocoding may be achieved, for example, via an address geocoding service 1.10. In some embodiments, if the particular location cannot be geocoded, the system may re-present the address to the user/traveler for correction as would be appreciated. In some embodiments, the system may present possible corrected locations for the user/traveler to choose.

In some embodiments, in an operation 1.05, the system may identify a number of travel depots (e.g., airports, etc.) closest to the initial origin and a number of travel depots closest to the ultimate destination. In some embodiments, the system may identify the five closest travel depots for the initial origin and five closest travel depots for the ultimate destination. In some embodiments, the travel depots are associated with the same transportation mode (e.g., airports). In some embodiments, the travel depots are associated with different transportation modes (e.g., airports and train stations). The closest travel depots may be identified by using the geocode to calculate the distance from the initial origin to each of its travel depots and the distance from the ultimate destination to each of its travel depots as would be appreciated.

In some embodiments, in an operation 1.06, the system may determine a drive time between the initial origin and each of its travel depots and between the ultimate destination and each of its travel depots. In some embodiments, the system may determine such drive times from, for example, via a mapping service 1.16 as would be appreciated. In some embodiments, the drive times may be used for computing potential routings. In some embodiments, the drive times may be subsequently adjusted by a user.

In some embodiments, in an operation 1.07, the system may determine a relevant time zone associated with the initial origin and a relevant time zone associated with the ultimate destination as would be appreciated. In some embodiments, the system may determine the time zone in which the data is entered which may correspond to either the location's local time or user's default time zone. In some embodiments, all relevant times may be converted to UTC and analyzed in that time zone exclusively to account for changes in time zones that may occur in a trip.

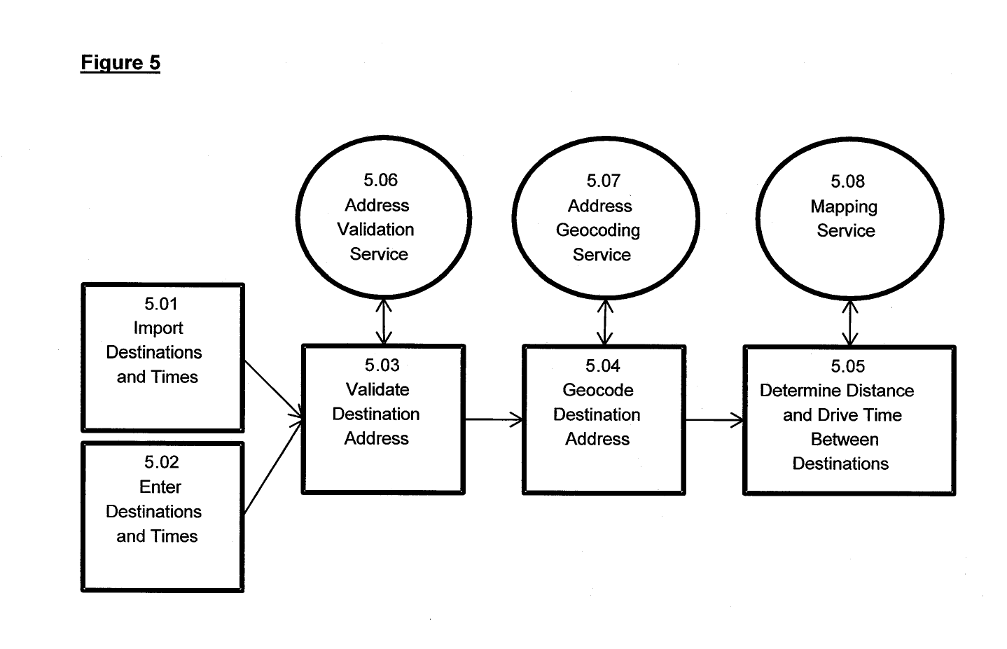

In some embodiments, in an operation 1.11, the system may create a request to a travel fare and/or availability service. In some embodiments, the system may create a request to an air fare and/or availability service, such as an air search service 1.12. In some embodiments, the system may first determine which travel legs may be appropriately accomplished by which transportation modes. For example, some short travel legs (e.g., less than three hours drive time) may not appropriately include air transportation and instead, may include a direct drive option as described below with reference to FIG. 5. In some embodiments, various settings may specify the minimum drive time before air travel is appropriate. In such embodiments, any travel legs may be accomplished by driving rather than by air. In some embodiments, various settings may specify the maximum drive time before air travel is required. In such embodiments, any travel legs may be accomplished by air rather than by driving. In some embodiments, drive times between the minimum drive time and the maximum drive time may be accomplished by driving or by air as would be appreciated and the system may provide potential routings for each of these transportation modes. For purposes of this description, the term “driving” may also include any non-air transportation medium or service as would be appreciated.

In some embodiments, for each travel leg that may include air transportation, the request may include a particular number of airports closest to the initial origin and a particular number of airports closest to the ultimate destination. In some embodiments, the request may include the five airports closest to the initial origin and the five airports closest to the ultimate destination. As would be appreciated, the request typically requires specifying a window during which travel will occur, and this window is typically defined by a departure window and an arrival window. Accordingly, in some embodiments of the invention, the request uses the earliest departure time and the latest arrival time for both the departure and arrival windows.

In some embodiments, in response to the request, the system receives one or more air fare data service responses in standardized format, such as XML and in an operation 1.13, filters such responses. In some embodiments the system parses the returned potential routings (which may be also be referred to as “solutions” by the air fare data service) by travel leg. The potential routings may then be evaluated or filtered to ensure that the air departure time is after the earliest departure time plus any drive time from the initial origin to the airport plus any check-in time for the airport plus any buffer time (if any). The potential routings may then be evaluated or filtered to ensure that the air arrival time is before the latest arrival time minus any drive time from the airport to the ultimate destination minus the check-out time for the airport minus the buffer time (if any). In some embodiments, the potential routings received from the air fare data service may be stored in the event that the user or traveler changes various settings, buffers, drive times, etc. Where a complete travel itinerary comprises multiple travel legs, the legs with air travel itineraries are provided in response to requests where one or more legs were excluded to account for direct driving (without air service), the air legs are joined with the appropriate driving leg(s) to develop complete itineraries.

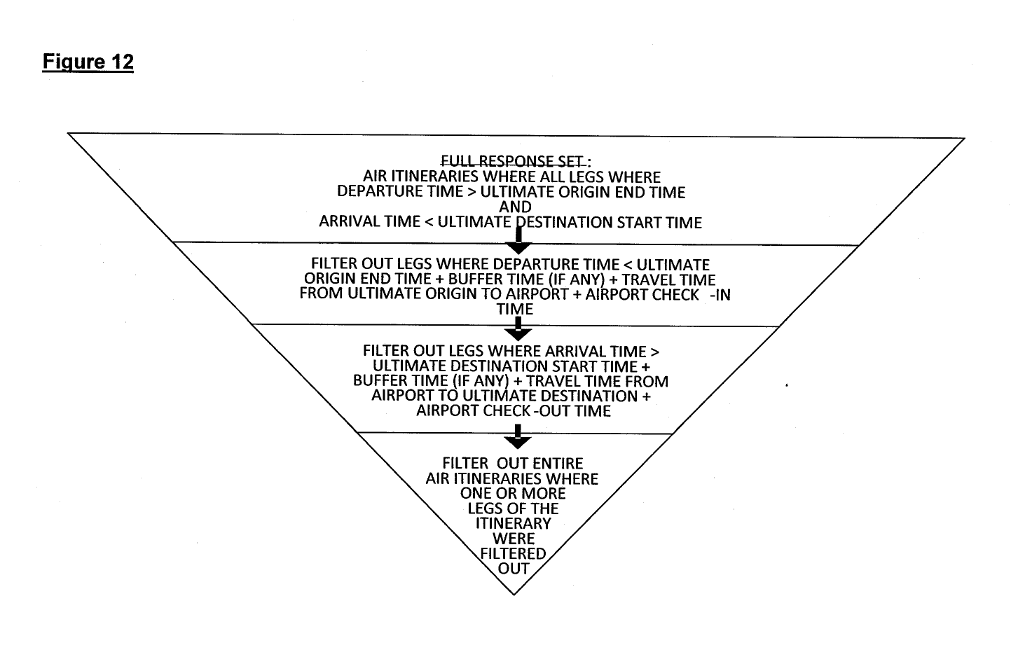

FIG. 12 illustrates various levels of filtering on the potential routings (e.g., flights) that may be performed by embodiments of the invention. In simple terms, a full response set from the air data service may include all potential routings (i.e., air itineraries) where departure time of the routing is after the earliest departure time and where the arrival time of the routing is before the latest arrival time. The full response set may then be filtered to remove those routings where the departure time of the routing does not allow for travel time from the initial origin to the departure airport, the buffer time (if any), or the airport check-in time. Likewise, the response set may be further filtered to remove those routings where arrival time of the routing does not allow for travel time from the arrival airport to the ultimate destination, the buffer time (if any), or the airport check-out time.

In some embodiments, a travel itinerary cost, or “total trip” cost, may be derived by adding a cost of transportation (e.g., air fare, train fare, etc.), a value of the travel time (calculated by adding drive time, check-in time, flight time, layover time, buffer time, etc. and multiplying the total time by an hourly rate of the traveler), the driving cost (which may be the actual ground transportation cost (e.g., cab fare, car service, etc.) including, but not limited to, fuel surcharges, tolls and other costs and/or calculating the mileage and applying a per mile rate), and a projected nightly per diem (which may be calculated by determining the number of nights between legs and multiplying it by a per night per diem). The nightly per diem may be used to estimate costs for meals, lodging, telecommunications and other daily costs. In some embodiments, a daily per diem (which may include or be in addition to the nightly per diem) may be used. In some embodiments, various components of the per diem (either nightly or daily) may include actual lodging costs (plus taxes, if available.) A user may determine to include only certain costs in their personal total trip cost.

In some embodiments, for the purpose of calculating overnight stays and to account for flights which technically depart the next day (shortly after midnight) where an overnight stay is really not required or for flights which technically arrive the next day (shortly after midnight) where an overnight stay is really is required, a user defined time period may be subtracted from the arrival and/or departure times on the flights so that late flights are correctly accounted for. For instance, a flight that arrives at 1 AM will need a hotel room even though it is the next day, however a flight that departs at 1 AM will not because it is considered a late flight from the day before (e.g., a red-eye).

In some embodiments, in an operation 1.14, potential routings may be scored to sort and rank them by monetary cost, time, user preferences or other scoring factors. In some embodiments, a score, or adjusted quality cost, may be derived by calculating the total trip cost and adding or subtracting various cost values attributed to the various scoring factors. The cost values may represent a dollar amount associated with the carrier or supplier preferences for each air travel segment and/or associated with the traveler's loyalty level at a given carrier or supplier for each air travel segment or other scoring factors described herein. The cost values may be determined by the user, the traveler or organization associated with the traveler and/or based on various travel policies associated with the traveler. Such cost values may serve to weight preferences and/or to assign a value to various benefits afforded to travelers at given loyalty levels with a particular carrier or supplier.

In some embodiments, potential routings may be scored based on weighting certain scoring factors based on a variable attribute associated with the scoring factor and/or the potential routing. For example, a particular scoring factor, such as seat type, may have a certain cost value for one type of seat that also varies depending on distance traveled. In other words, a middle seat on a flight might have a low cost value on short flights and a high cost value on long flights. In some embodiments, this might be accomplished by specifying a cost value for a middle seat as a fixed cost (that generally distinguishes the middle seat from either an aisle seat or a window seat) plus a variable cost that changes based on some function of distance traveled (e.g., linearly, exponentially, etc.). Similar adjustments based on distance traveled may be used to weight other scoring factors such as user preferences (i.e., give higher weight to user preferences on longer flights). Other adjustments based on other attributes may be used to weight other scoring factors such as carrier preference (i.e., give higher weight to a preferred carrier based on number of flights in a travel itinerary, give higher weight to a preferred carrier based on existing frequent flyer miles or number of frequent flyer miles needed to next level of status, etc.).

In some embodiments of the invention, the system determines fares of various potential routings (e.g., air fares, train fares, etc.) based on a point of purchase for the potential routing. For example, in many cases, a flight from New York to London may have one price if booked/ticketed from the U.S. and another price if booked/ticketed from the U.K. or the European continent. In other words, the fare for the identical flight may be dependent on the location from which the flight is purchased. This difference in fare prices (or fare differential), accompanied by exchange rates between currencies, if applicable, may be arbitraged. Accordingly, in various embodiments, the system may specify different points of purchase or utilize third parties to obtain fares of various potential routings and/or subsequently purchase specific routings to exploit these fare differentials. In various embodiments of the invention, the system may further capture exchange rates based on the respective currencies as would be appreciated.

In some embodiments, in an operation 1.15, the scored potential routings are presented to the user or traveler in various forms as described above.

While the foregoing description has been made with reference to air travel, similar processing may occur for other transportation modes as would be appreciated.

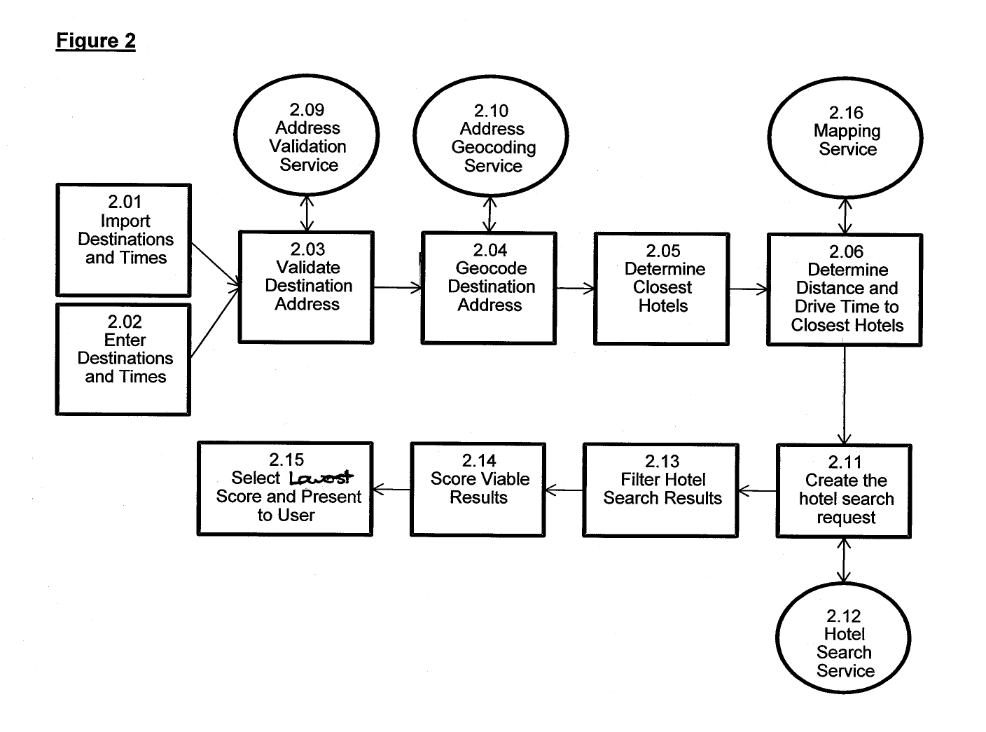

FIG. 2 illustrates various operations for determining potential lodging options according to various embodiments of the invention. In some embodiments, the system receives the ultimate destination, and/or a latest arrival time. As illustrated, the system may receive such information via a user/traveler entering such information into the system, for example in operation 2.02, or the system may receive such information by importing such information from, for example, an electronic calendar of the traveler, in operation 2.01.

In some embodiments, the system may receive information regarding one or more specific appointment(s) or event(s) of the traveler at each ultimate destination, including, but not limited to, the address(es), start and end times, and time buffers before the start time(s) and after the end time(s) of the appointments.

In an operation 2.03, the system may validate addresses associated with each specific appointment and/or each ultimate destination (or other relevant location input). Such validation may be obtained, for example, via an address validation service 2.09. In some embodiments, in an operation 2.04, the system may geocode each specific appointment and/or ultimate destination, (or other relevant location input). Such geocoding may be achieved, for example, via an address geocoding service 2.10. In some embodiments, if the particular location cannot be geocoded, the system may re-present the address to the user/traveler for correction as would be appreciated. In some embodiments, the system may present possible corrected locations for the user/traveler to choose.

For each period of time between travel legs (i.e., ground periods) where there is an overnight stay or for each travel leg that requires an overnight stay, in an operation 2.05, the system may identify potential lodging options near or closest to a location of the ultimate destination (in the case of a single appointment at the ultimate destination) or a particular appointment (in the case of multiple appointments beginning with one at the ultimate destination). In some embodiments, the particular appointment may be the last appointment of the day on the traveler's calendar. In some embodiments, the particular appointment may be the first appointment of the next day on the traveler's calendar. In some embodiments, the user or traveler may designate a particular appointment for determining appropriate lodging options. The closest potential lodging options may be identified by using the geocode to calculate the distance from the ultimate destination and/or specific appointments to each of the potential lodging options as would be appreciated.

In some embodiments, in an operation 2.06, the system may calculate various distances and/or drive times between evaluated appointments on adjacent days and may attempt to keep a traveler in particular lodging option for multiple days when evaluated appointments are within a certain geographic vicinity, calculated by drive time and/or mileage. The potential lodging options may be restricted or filtered by distance, by drive time or by a certain number of results (e.g. 5), or other criteria, or combinations thereof. In some embodiments, the system may retrieve such distances from a mapping service 2.16.

In some embodiments, in an operation 2.11, for each of potential lodging options, the system retrieves applicable rates from one or more hotel availability and pricing service(s) 2.12. In some embodiments, in an operation 2.12, the system may include or exclude certain rates or room types, depending on specification of the traveler, the traveler's group's or organization. For any given itinerary, the check-in date may be based on the earliest the traveler would be able to arrive at their appointment (the flight arrival time, plus airport check-out time, plus drive time to appointment) and the check-out date may be based on the latest the traveler would be able to leave their appointment (the flight departure time, minus drive time to airport, minus airport check-in time).

In some embodiments, in an operation 2.14, the system may score each available potential lodging option using a number of factors, including, but not limited to: the lowest price for the room (and tax, if available for calculation); the traveler's preference for hotel brand; the traveler's status with the hotel brand; past reviews of the hotel by traveler or other travelers; traveler's, group's, or organization's preference for hotel brand or particular property; available amenities and cost (e.g.: wireless internet, business center) distance from appointment; and/or quality level/category of the hotel (star rating or luxury category). These factors may be translated to a cost value which may increase or decrease the value of a given option. The weighting of the factors may also be configured by a user, a group, or organization.

In some embodiments, in an operation 2.15 the available potential lodging option with the lowest score (i.e., lowest cost) is then automatically selected as the default. A user can elect to view other potential lodging options and apply them to their itinerary. Groups or organizations may place a restriction on the total value a user can select either by absolute dollar monetary value, score, or either as a percentage over the lowest available potential lodging option. These restrictions can block a selection outside of those parameters, or alternatively can be warnings for later analysis. In some embodiments, the lodging options searched may be restricted by price category or other factors to eliminate undesirable options and/or reduce the number of inquiries made to the hotel availability and pricing service(s).

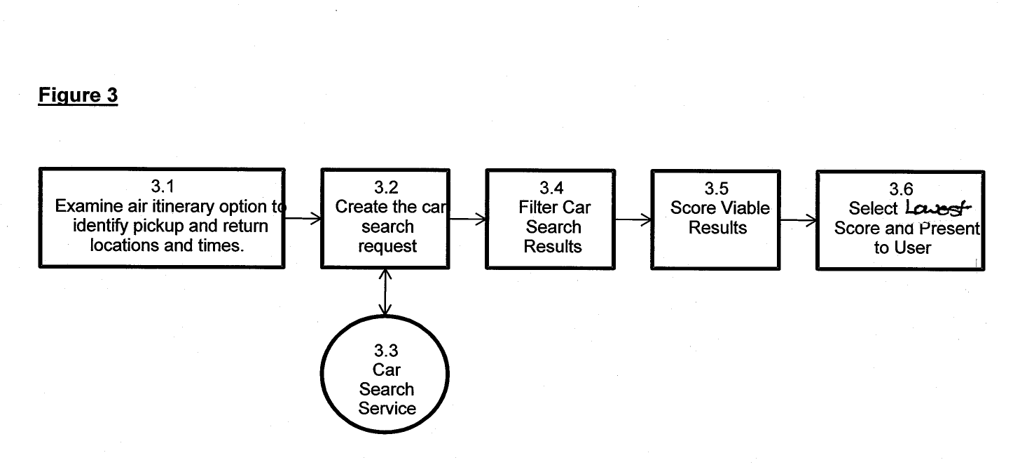

FIG. 3 illustrates various operations for determining potential ground transportation options (e.g., car rentals, car/limousine services, etc.) according to various embodiments of the invention. In an operation 3.1, the system evaluates various potential routings (e.g., air itinerary, train itinerary, etc.) to identify potential ground transportation pick-up and return locations. In some embodiments, the pick-up location is the travel depot at which the traveler arrives and the return location is the travel depot from which the traveler departs. For each period of time between flight legs (i.e., ground periods), in an operation 3.2, the system identifies a list of available potential ground transportation options. In some embodiments, the system retrieves applicable rental rates from one or more car availability and pricing service(s) 3.3. In some embodiments, in an operation 3.4, the system may include or exclude (i.e., filter) certain types, or rates, depending on the traveler or group's profile. By default, for any given ground period, the pick-up date/time may be the arrival time of the transportation mode (e.g., flight) and the return date/time may be the departure time of the transportation mode so that the period covers the entire time that a traveler is on the ground, however this may be customized by the user or group.

In some embodiments, in an operation 3.5, each available potential ground transportation option is then scored by a number of factors, including, but not limited to: the lowest rate for the car rental (and tax, if available for calculation); the traveler's preference for car rental provider brand; the traveler's status with the car rental provider brand; traveler's or group's preference for car rental provider brand; available amenities and cost; and/or quality level/category of the car (star rating or luxury category). The factors are each translated to a cost value which may increase or decrease the value of a given option. The weighting of the factors may also be configured by a user, a group, or an organization. In some embodiments, in an operation 3.6, the potential ground transportation option with the lowest score (e.g., lowest cost) is then automatically selected as the default. A user can elect to view other options and apply them to their itinerary.

Groups may place a restriction on the total value a user can select either by absolute dollar monetary value, score, or either as a percentage over the lowest available option. These restrictions may block a selection outside of those parameters, or alternatively can be warnings for later analysis. The car rental providers, car types, or car services sought may be restricted by price category or other factors to eliminate undesirable options and/or reduce the number of inquiries made to the car availability and pricing service(s).

In some embodiments, instead of or in addition to car rentals and/or car/limousine services, other ground transportation options may be used such as, but not limited to, taxi, public transportation (metrorail, bus, ferry, boat, etc.), and/or any other private or public, scheduled or unscheduled non-air transportation.

Any of the search and selection processes may limit selection by user or group on the basis of price, supplier, carrier, property, or any other parameter. Such basis may be absolute or relative to available options. These limitations may be configured by a user, group, or organization and may fully restrict or flag violations.

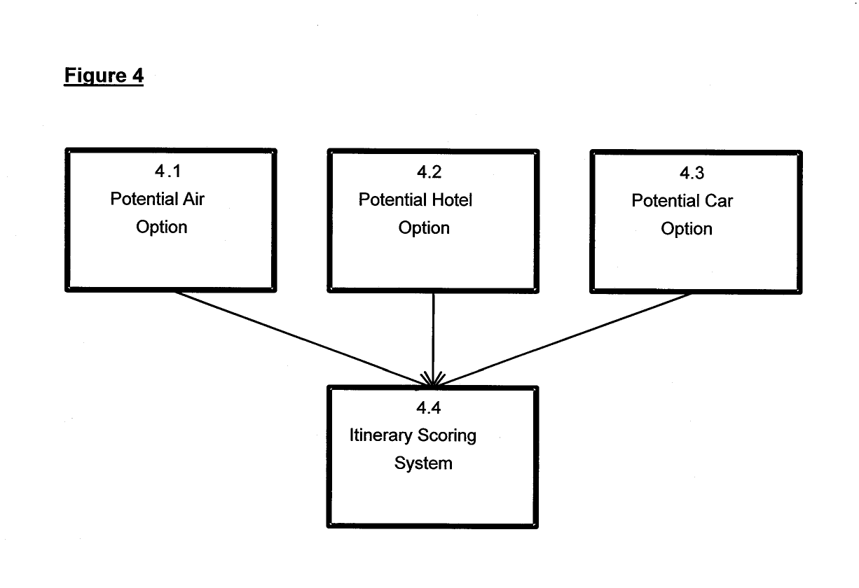

While various embodiments of the invention are described above in relation to evaluating and scoring individual components of a travel itinerary (i.e., individually evaluating potential routings (e.g., flights or other routings), individually evaluating potential lodging options, and individually evaluating potential ground transportation options), some embodiments of the invention, such as that illustrated in FIG. 4, aggregate two or more of the individual travel components and then score the aggregated components as a complete travel itinerary. In other words, various aggregations of potential routings, potential lodging options, and/or potential ground transportations options may be scored on the basis of complete itineraries. In doing so, various synergies (e.g., cost incentives, loyal incentives, coupons, preferred partners, etc.) that might exist between the potential options may be captured and factored into the scoring of the complete itinerary as would be appreciated.

FIG. 5 illustrates various operations for determining potential direct drive options (i.e., non flight options) according to various embodiments of the invention. In some embodiments, the system receives the initial origin and the ultimate destination, and/or a latest arrival time. As illustrated, the system may receive such information via a user/traveler entering such information into the system, for example in operation 5.02, or the system may receive such information by importing such information from, for example, an electronic calendar of the traveler, in operation 5.01.

In some embodiments, the system may receive information regarding one or more specific appointment(s) or event(s) of the traveler at each ultimate destination, including, but not limited to, the address(es), start and end times, and time buffers before the start time(s) and after the end time(s) of the appointments.

In an operation 5.03, the system may validate addresses associated with each specific appointment and/or each ultimate destination (or other relevant location input). Such validation may be obtained, for example, via an address validation service 5.06. In some embodiments, in an operation 5.04, the system may geocode each specific appointment and/or ultimate destination, (or other relevant location input). Such geocoding may be achieved, for example, via an address geocoding service 5.07. In some embodiments, if the particular location cannot be geocoded, the system may re-present the address to the user/traveler for correction as would be appreciated. In some embodiments, the system may present possible corrected locations for the user/traveler to choose.

In some embodiments, in an operation 5.05, the system may calculate various distances and/or drive times between the initial origin and ultimate destinations and/or specific appointments. In some embodiments, the system may retrieve such distances from a mapping service 5.08. As discussed above, in some embodiments of the invention, these direct drive options may be evaluated, filtered and/or scored in connection with or as part of the potential routings described above with respect to FIG. 1.

Once a travel itinerary has been presented to the user/traveler and selected for booking, various embodiments automatically book (i.e., without additional action from the user/traveler) the various components of the itinerary, namely the selected routing, the selected lodging option, and/or the selecting ground transportation option. Booking the complete itinerary may be accomplished by purchasing one or more components via a travel consolidator, by purchasing individual components directly from the respective suppliers, and/or combinations thereof. As would be appreciated, purchasing various components of the travel itinerary may occur through a channel similar to or different from the channels used to gather the original transportation information. Regardless of the manner in which the travel itinerary is booked or components thereof purchased, in some embodiments, the booked travel itinerary may be provided to the traveler in a consolidated manner, for example, in the form of one or more links to electronic tickets, electronic reservations, etc. In some embodiments, payment for the travel itinerary may automatically be accomplished via payment information stored for the traveler or the traveler's organization, direct invoicing to the traveler or the traveler's organization, or other automatic payment mechanisms as would be appreciated.

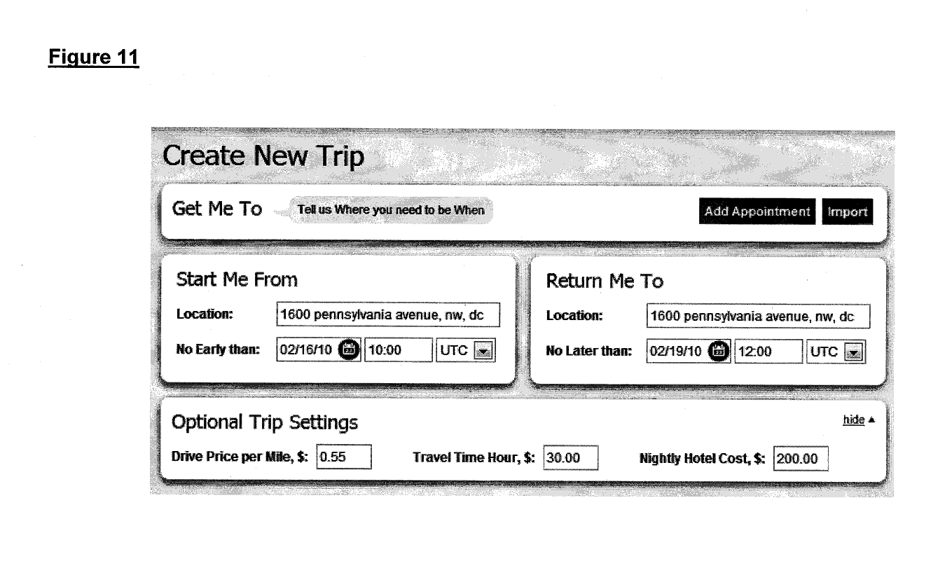

FIG. 11 illustrates an exemplary graphical user interface (GUI) for providing user inputs to create a new trip according to various embodiments of the invention. More particularly, this GUI may be used to enter user inputs into various embodiments of the invention to identify, schedule and/or book an itinerary. As illustrated in FIG. 11, the GUI includes a “Start Me From” portion that permits the user to enter an initial origin (i.e., “location”) and an earliest departure time (i.e., “no early than”); and the GUI includes a “Return Me To” portion that permits the user to enter an ultimate destination (i.e., “location”) and a latest arrival time (i.e., “no later than”). As also illustrated, the GUI permits the user to specify one or more scoring factors, namely “drive price per mile,” “travel time/hour” and “nightly hotel cost,” that are associated with the traveler and/or its travel policies.

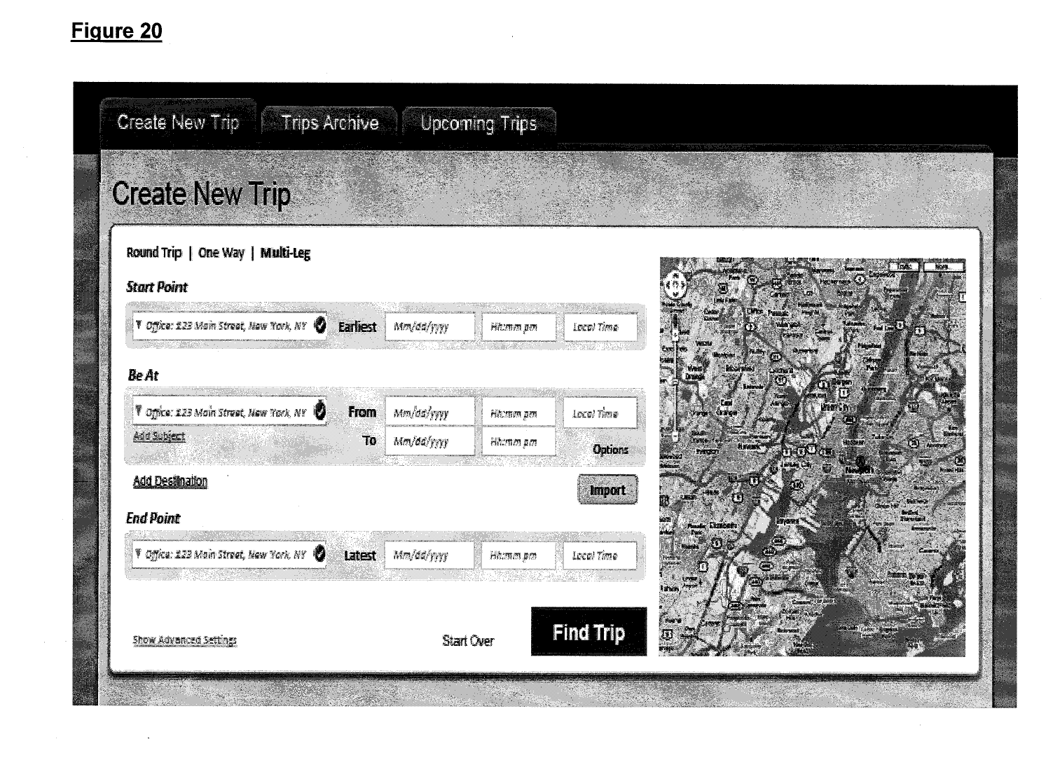

FIG. 20 illustrates another exemplary graphical user interface (GUI) for providing user inputs to create a new trip according to various embodiments of the invention. More particularly, this GUI may be used to enter user inputs into various embodiments of the invention to identify, schedule and/or book an itinerary. As illustrated in FIG. 11, the GUI includes a “Start Point” portion that permits the user to enter an initial origin and an earliest departure time (i.e., “Earliest”); and the GUI includes a “Be At” portion that permits the user to enter an ultimate destination (i.e., “location”) and a latest arrival time (i.e., “From”). This GUI also includes an “End Point” portion that permits the user to enter a return location and a return time (i.e., “Latest”).

According to various aspects of the invention, the GUI permits the user to specify “Where” and “When,” namely the ultimate destination and latest arrival time, for purposes of planning and booking a complete itinerary.

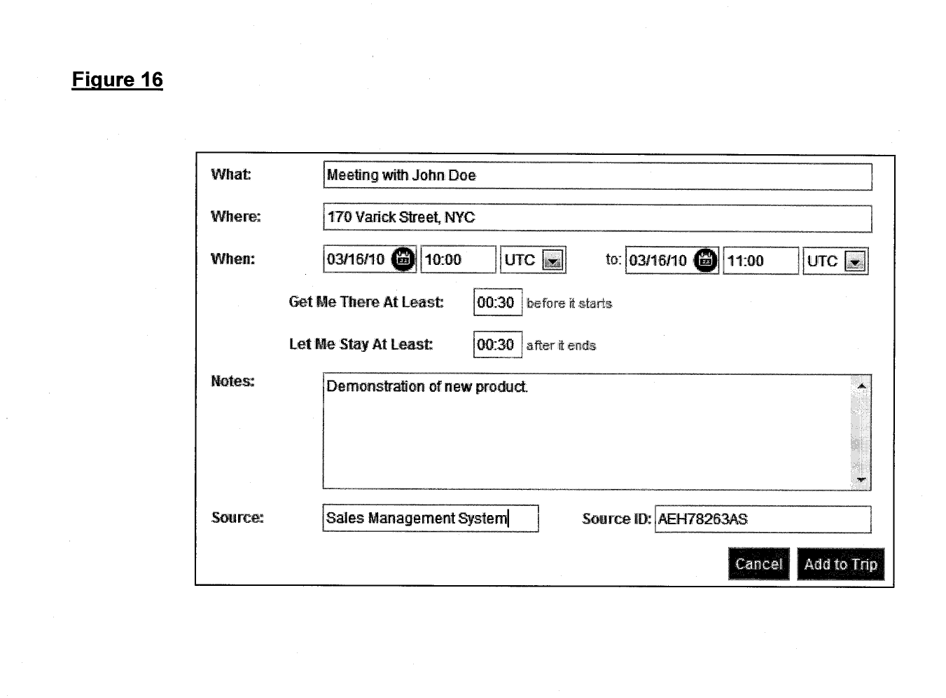

FIG. 16 illustrates an exemplary graphical user interface (“GUI”) representative of inputs (specifically from a user appointment or calendar item) that might be imported by various embodiments of the invention to identify, schedule and/or book an itinerary. In particular, the GUI includes the “Where” of the appointment (which corresponds to the ultimate destination of the trip) and the “When” of the appointment (which corresponds to the latest arrival time of the trip). According to various aspects of the invention, the “Where” and “When” may be used to identify, schedule and book a complete itinerary (or in multi-leg trips, a portion of the complete itinerary). In some embodiments, the end time of a given appointment may subsequently be used as an earliest departure time for the next travel leg.

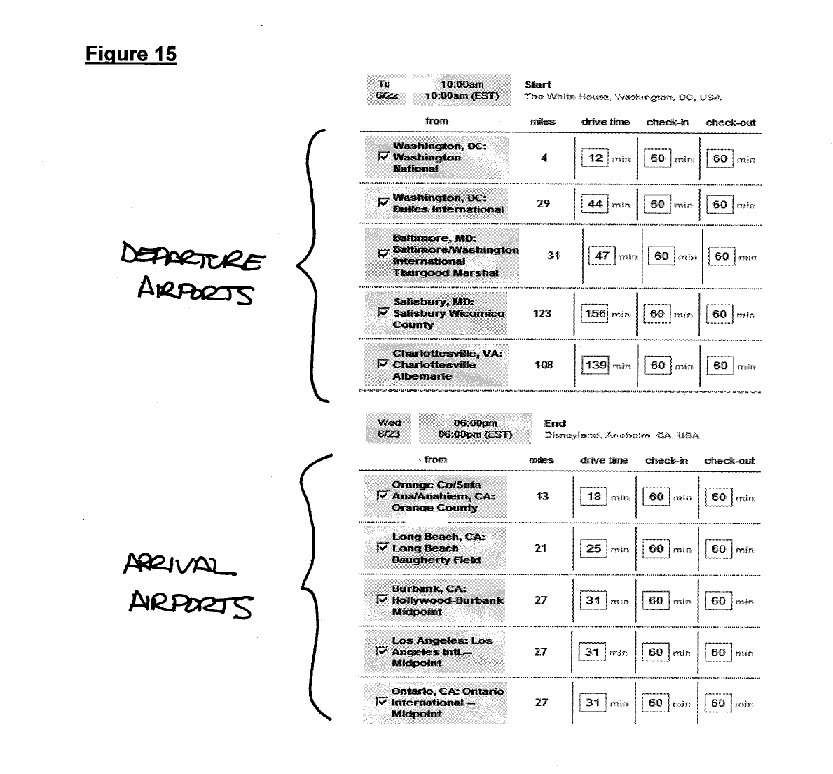

FIG. 15 illustrates an exemplary graphical user interface (“GUI”) that may be presented to the user regarding various times associated with the travel leg according to various embodiments. As illustrated, the GUI presents the starting location (i.e., initial origin) and the starting time (i.e., earliest departure time) as well as the ending location (i.e., ultimate destination) and the ending time (i.e., latest arrival time). As also illustrated, the GUI presents the number of miles between the initial origin and each of the departure airports and the associated drive time; and the GUI presents the check-in time associated with each of the departure airports and the check-out time associated with each of the departure airports. As also illustrated, the GUI presents the number of miles between the ultimate destination origin and each of the arrival airports and the associated drive time; and the GUI presents the check-in time associated with each of the arrival airports and the check-out time associated with each of the arrival airports. As suggested, the GUI may permit the user to adjust various items including the drives times, the check-in times, and the check-out times as described above.

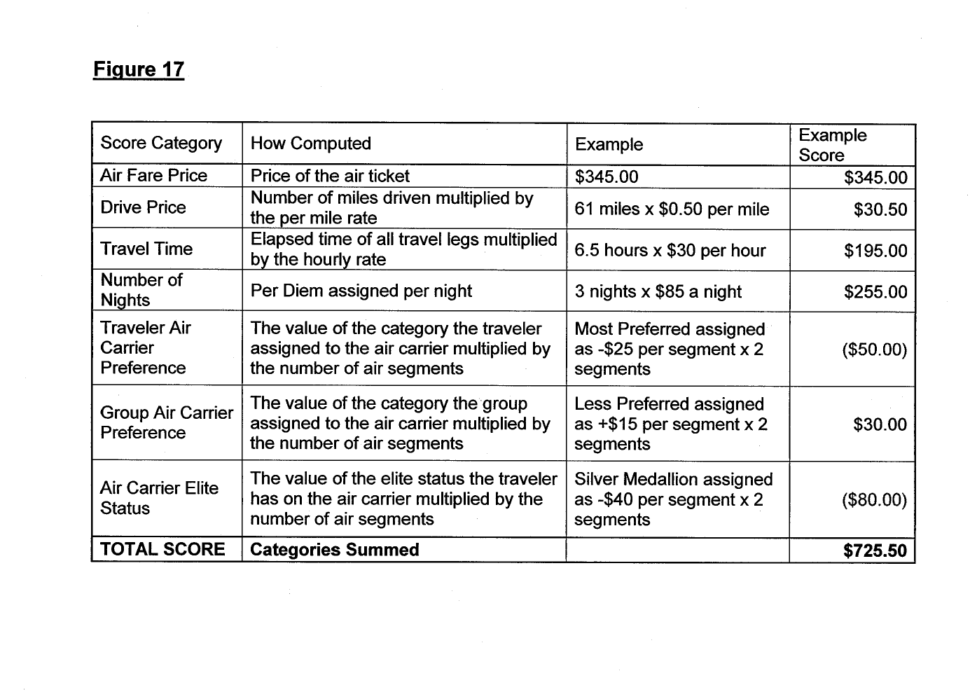

FIG. 17 illustrates an exemplary formula for scoring potential routings (i.e., air service) in accordance with various embodiments of the invention. As illustrated, this formula may include air fare price, drive price, travel time, number of nights, traveler air carrier preference, group air carrier preference, and air carrier elite status. As also illustrated, the formula identifies actual costs (and their calculations) associated with various factors affecting the formula as well as adjustments (and their calculations) to those actual costs based on, for example, preferences and status. The formula may use more, fewer, or other factors and/or other adjustments relative to those factors used as would be appreciated. The costs and adjustments may be accumulated to determine a total score for the potential routing.

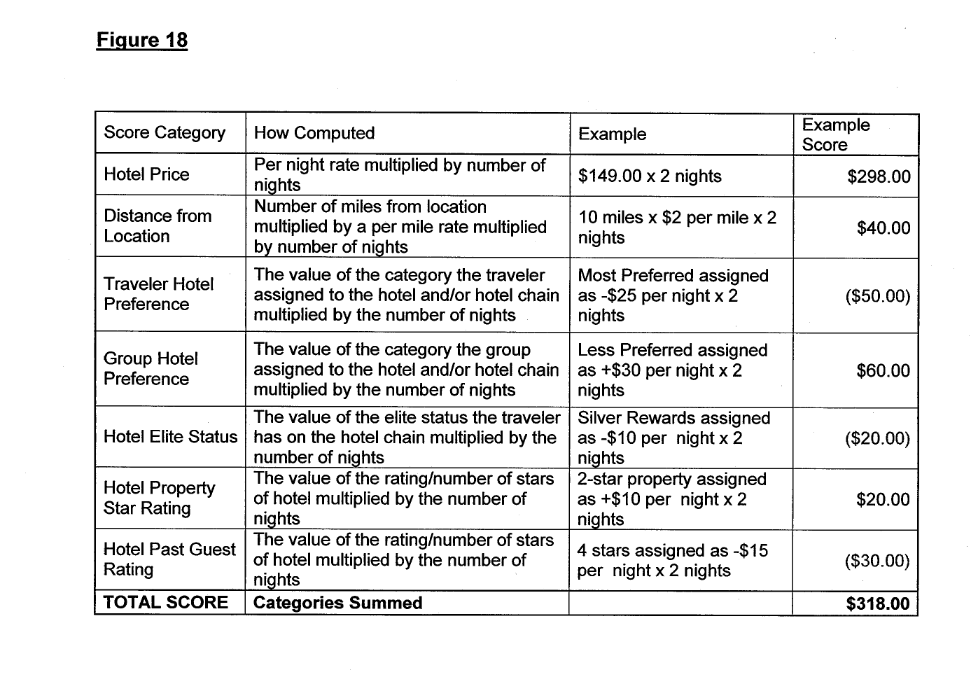

FIG. 18 illustrates an exemplary formula for scoring potential lodging options (i.e., hotels) in accordance with various embodiments of the invention. As illustrated, this formula may include hotel price, distance from location, traveler hotel preference, group hotel preference, hotel elite status, hotel property rating, and hotel past guest rating. As also illustrated, the formula identifies actual costs (and their calculations) associated with various factors affecting the formula as well as adjustments (and their calculations) to those actual costs based on, for example, preferences, status, etc. The formula may use more, fewer, or other factors and/or other adjustments relative to those factors used as would be appreciated. The costs and adjustments may be accumulated to determine a total score for the potential lodging option.

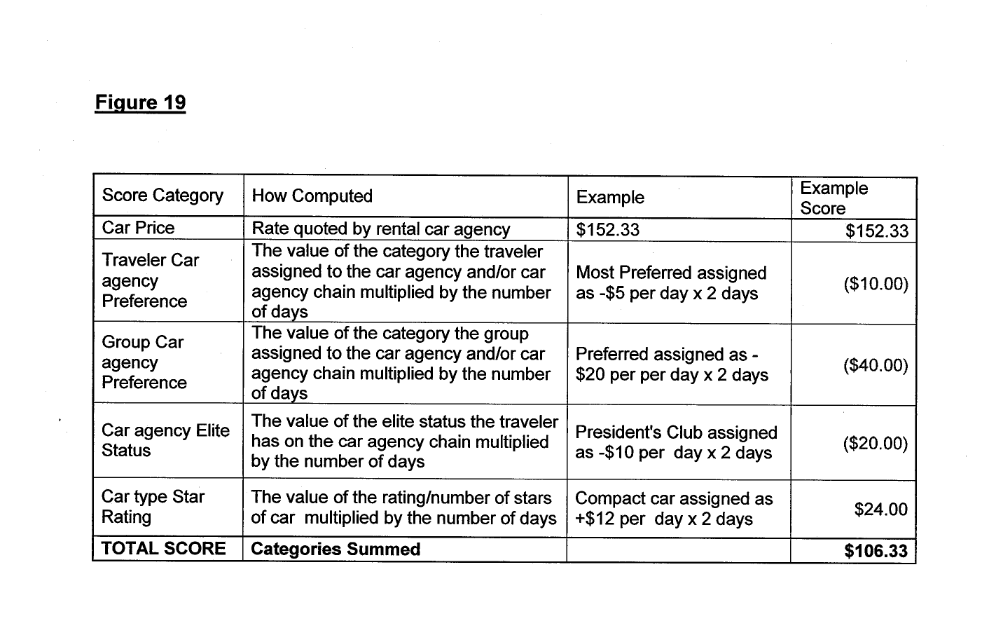

FIG. 19 illustrates an exemplary formula for scoring potential ground transportation options (i.e., car rental) in accordance with various embodiments of the invention. As illustrated, this formula may include car price, traveler car agency preference, group car agency preference, car agency elite status, and car type star rating. As also illustrated, the formula identifies actual costs (and their calculations) associated with various factors affecting the formula as well as adjustments (and their calculations) to those actual costs based on, for example, preferences, status, etc. The formula may use more, fewer, or other factors and/or other adjustments relative to those factors used as would be appreciated. The costs and adjustments may be accumulated to determine a total score for the potential ground transportation option.

In some embodiments, the exemplary formulas illustrated in FIGS. 17, 18 and 19 may be combined (e.g., added) to generate a total score for a complete itinerary as described above. In addition, in some embodiments, additional adjustments may be factored into the total score based on synergies among the various components as described above.

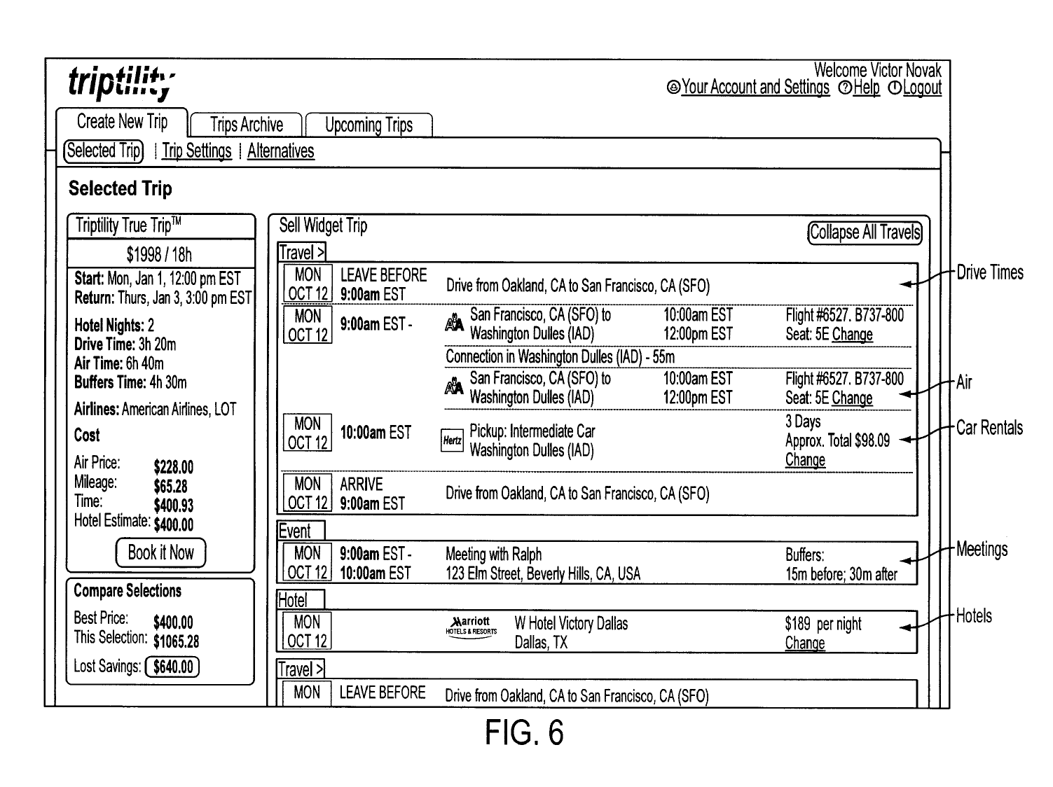

FIG. 6 illustrates an exemplary graphic user interface (“GUI”) that may be used to present the user with a complete itinerary according to various embodiments. As illustrated, the complete itinerary includes drive times (e.g., drive time from the initial origin (Oakland, Calif.) to the departure airport (SFO)), an airline ticket (e.g. roundtrip flight between SFO and IAD), a car rental (e.g., Hertz rental at IAD), and a hotel reservation (e.g., Marriot). As illustrated, the complete itinerary may be presented with a total cost (e.g., $1988) and a travel duration (e.g., 18 h). As illustrated, the complete itinerary may also be presented with a comparison to other itineraries.

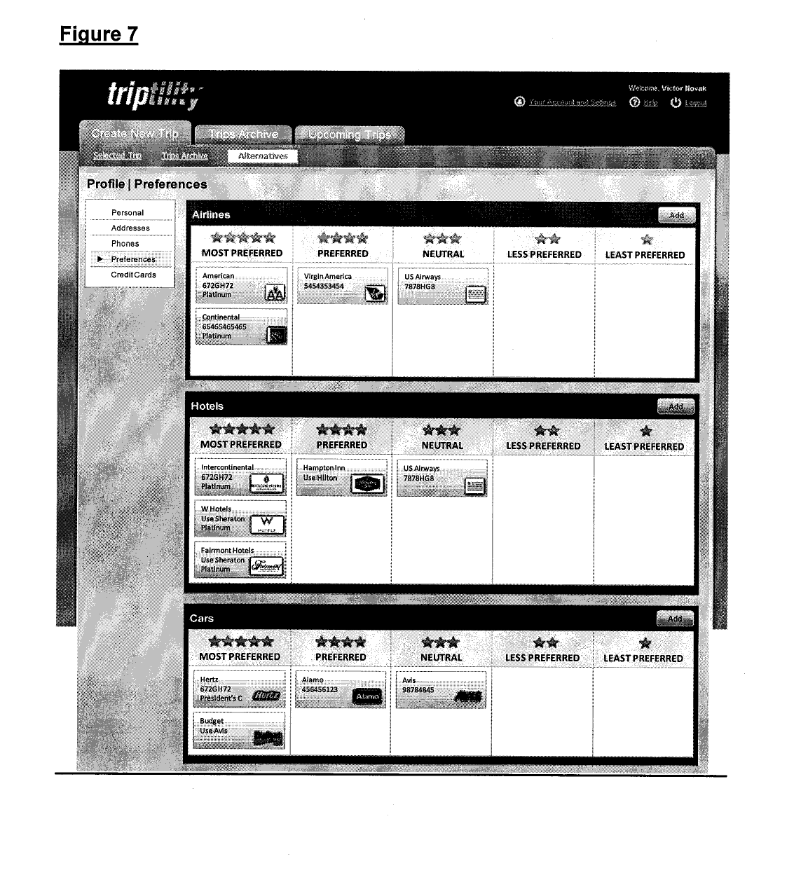

FIG. 7 illustrates an exemplary graphic user interface (“GUI”) of a traveler's profile including supplier frequent traveler accounts, status and preferences, in accordance with various embodiments.

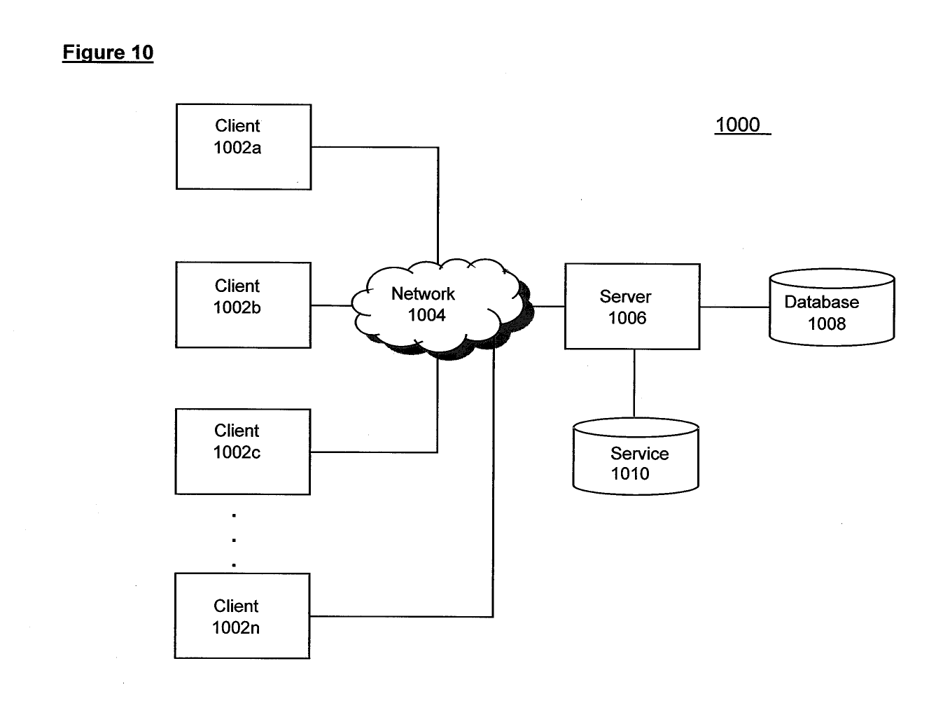

FIG. 10 illustrates an environment 1000 in which various embodiments of the invention operate. As illustrated, environment 1000 includes a plurality of clients 1002 (illustrated as a client 1002a, a client 1002b, a client 1002c, . . . , and a client 1002n) on which various embodiments of the invention may operate or be deployed; a server 1006 on which various embodiments of the invention may operate or be deployed; one or more databases 1008 coupled to server 1006, either directly or through a network (not illustrated); and one or more services 1010 coupled to server 1006, either directly or through a network (not illustrated). As would be appreciated, users/travelers may access server through clients 1002 via network 1004. Such a “client-server” system is well understood as would be appreciated.

The features, structures, or characteristics of the invention described throughout this specification may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the relevant art will readily understand that the invention as described above may be practiced with steps in a different order, and/or with hardware elements in configurations which are different than those which are disclosed. The embodiments described above may be practiced or applied independently or may be combined in any appropriate manner. Therefore, although the invention has been described based upon these embodiments, it would be apparent to those of skill in the art that certain modifications, variations, and alternative constructions would be apparent, while remaining within the spirit and scope of the invention.

What is claimed:

1. A computer-implemented method for generating a travel itinerary comprising:
receiving an initial origin that specifies a beginning location for a traveler;
receiving an ultimate destination that specifies an ending location for the traveler;
determining a plurality of travel depots near the initial origin;
determining a plurality of travel depots near the ultimate destination;
receiving a plurality of potential routings between the plurality of travel depots near the initial origin and the plurality of travel depots near the ultimate destination, wherein each of the potential routings includes a departure time, an arrival time, and a fare;
filtering the plurality of potential routings based on either the departure time of each of the plurality of potential routings or the arrival time of each of the plurality of the potential routings;
scoring the filtered plurality of potential routings based on the fare associated with each of the filtered plurality of potential routings; and
providing the scored plurality of potential routings to a user.

2. The method of claim 1, further comprising:
receiving an earliest departure time that specifies a time on or after which the traveler is available to leave the initial origin; and
receiving a latest arrival time that specifies a time on or before which the traveler should arrive at the ultimate destination,
wherein the filtering the plurality of potential routings based on either the departure time of each of the plurality of potential routings or the arrival time of each of the plurality of the potential routings comprises filtering the plurality of potential routings based on the departure time of each of the plurality of potential routings, the arrival time of each of the plurality of the potential routings, the earliest departure time and the latest arrival time.

3. The method of claim 2, further comprising:
determining a drive time between the initial origin and each of the plurality of travel depots near the initial origin; and
determining a drive time between the ultimate destination and each of the plurality of travel depots near the ultimate destination,
wherein filtering the plurality of potential routings based on the departure time of each of the plurality of potential routings, the arrival time of each of the plurality of the potential routings, the earliest departure time, the latest arrival time, the drive time between the initial origin and each of the plurality of travel depots near the initial origin, and the drive time between the ultimate destination and each of the plurality of travel depots near the ultimate destination.

4. The method of claim 1, further comprising determining a drive time between the initial origin and the ultimate destination.

5. The method of claim 1, wherein the initial origin is not one of the plurality of travel depots near the initial origin or wherein the ultimate destination is not one of the plurality of travel depots near the ultimate destination.

6. The method of claim 1, wherein one of the plurality of routings corresponds to a different transportation mode than another of the plurality of routings.

7. The method of claim 1, wherein determining a drive time between the initial origin and each of the plurality of travel depots near the initial origin comprising receiving mapping information from a mapping service.

8. The method of claim 1, wherein determining a plurality of travel depots near the initial origin comprises determining a plurality of travel depots closest to the initial origin.

9. The method of claim 1, wherein scoring the filtered plurality of potential routings comprises scoring the filtered plurality of potential routings based one or more of the following: a duration of travel for each of the filtered plurality of potential routings or a duration of travel from the initial origin to the ultimate destination.

10. The method of claim 1, wherein scoring the filtered plurality of potential routings comprises scoring the filtered plurality of potential routings based one or more of the following: rental car costs, mileage reimbursement costs, or fuel costs.

11. The method of claim 1, wherein scoring the filtered plurality of potential routings comprises scoring the filtered plurality of potential routings based one or more of the following: hotel costs, per diem costs, or cost of time for travel.

12. The method of claim 1, wherein scoring the filtered plurality of potential routings comprises scoring the filtered plurality of potential routings based one or more of the following: traveler preferences, group preferences, or organizational preferences.

13. The method of claim 1, wherein scoring the filtered plurality of potential routings comprises scoring the filtered plurality of potential routings based one or more of the following: seat availability, “on-time” arrival percentages, “on-time” departure percentages, historical actual departure time, historical actual arrival time, predicted actual departure time, predicted actual arrival time, upgrade availability, seat class, seat type, number of connections, duration of layovers, or geographic location of connection.

14. The method of claim 1, further comprising:
receiving a plurality of potential lodging options near the ultimate destination, wherein each of the plurality of potential lodging options includes a nightly rate.

15. The method of claim 14, further comprising:
scoring the plurality of potential lodging options based on the fare associated with each of the plurality of potential lodging options.

16. The method of claim 15, further comprising:
providing a travel itinerary of a trip between the initial origin and the ultimate destination based one or more of the scored plurality of potential routings and one or more of the scored plurality of potential lodging options, wherein the travel itinerary comprises one of the scored plurality of potential routings and one of the scored plurality of potential lodging options.

17. The method of claim 16, further comprising:
in response to selection of the travel itinerary:
booking the one of the scored plurality of potential routings, and
booking the one of the scored plurality of potential lodging options.

18. The method of claim 15, further comprising:
scoring a plurality of itineraries for a trip between the initial origin and the ultimate destination based one or more of the scored plurality of potential routings and one or more of the scored plurality of potential lodging options.

19. The method of claim 18, further comprising:
providing an optimal itinerary to the user based on the scored plurality of itineraries, the optimal itinerary comprising one of the scored plurality of potential routings and one of the scored plurality of potential lodging options; and
in response to selection of the optimal itinerary:
booking the one of the scored plurality of potential routings, and
booking the one of the scored plurality of potential lodging options.

20. The method of claim 2, wherein receiving an ultimate destination comprises receiving the ultimate destination from an electronic calendar associated with the traveler; and
wherein receiving a latest arrival time comprises receiving the latest arrival time from the electronic calendar associated with the traveler.

21. A computer-implemented method for generating a travel itinerary comprising:
receiving an ultimate destination that specifies an ending location for a traveler;
receiving a latest arrival time that specifies a time on or before which the traveler should arrive at the ultimate destination;
determining a plurality of travel depots near an initial origin of the traveler;
determining a plurality of travel depots near the ultimate destination;
receiving a plurality of potential routings between the plurality of travel depots near the initial origin and the plurality of travel depots near the ultimate destination, wherein each of the potential routings includes an arrival time and a fare;
filtering the plurality of potential routings based on the arrival time of each of the plurality of the potential routings;
scoring the filtered plurality of potential routings based on the fare associated with each of the filtered plurality of potential routings; and
providing the scored plurality of potential routings to a user.

22. The method of claim 21, further comprising:
determining a drive time between the ultimate destination and each of the plurality of travel depots near the ultimate destination,
wherein filtering the plurality of potential routings comprises filtering the plurality of potential routings based on the arrival time of each of the plurality of the potential routings, the latest arrival time, and the drive time between the ultimate destination and each of the plurality of travel depots near the ultimate destination.

23. The method of claim 21, further comprising:
determining whether an overnight stay is required for each of the filtered plurality of potential routings based on the arrival time of each of the filtered plurality of potential routings and the latest arrival time; and
determining a plurality of potential lodging options near the ultimate destination, wherein each of the plurality of potential lodging options includes a nightly rate,
wherein scoring the filtered plurality of potential routings comprises scoring each of the filtered plurality of potential routings that require the overnight stay based on the associated fare and the nightly rate of at least one of the plurality of potential lodging options.

24. The method of claim 21, further comprising receiving the initial origin.

25. The method of claim 21, further comprising retrieving the initial origin.

26. The method of claim 21, further comprising determining the initial origin as the actual location of the traveler.
